(19) United States
(12) Patent Application Publication
(10) Pub. No.: US 2023/0344338 A1
(43) Pub. Date: Oct. 26, 2023

(54) METHOD FOR OPERATING A SWITCHED-MODE POWER SUPPLY UNIT, AND VOLTAGE SUPPLY DEVICE

(71) Applicant: Robert Bosch GmbH, Stuttgart (DE)

(72) Inventor: Axel Haas, Oberstenfeld (DE)

(21) Appl. No.: 18/042,865

(22) PCT Filed: Jul. 15, 2021
(86) PCT No.: PCT/EP2021/069767

§ 371 Date: Feb. 24, 2023

(30) Foreign Application Priority Data
Aug. 24, 2020 (DE) 10 2020 210 708.4

(51) Int. Cl. H02M 3/157; H02M 1/32; H02M 1/00

(52) U.S. Cl. CPC H02M 3/157; H02M 1/32; H02M 1/0012

(57) ABSTRACT

The invention relates to a method (200) for operating a switched-mode power supply unit (120), comprising capturing (210) at least one operating parameter of the switched-mode power supply unit (120), determining (220), using the at least one operating parameter, a variable of the switched-mode power supply unit (120), said variable being dependent on an output power, comparing (230) the variable dependent on the output power with a power threshold value, and carrying out a measure (240), which more particularly comprises lowering the output power of the switched-mode power supply unit (120), if the determined output power exceeds the power threshold. Further proposed is a voltage supply device (100) designed to carry out such a method (200).

### BACKGROUND OF THE INVENTION

The present invention relates to a method for operating a switched-mode power supply unit and to a voltage supply device.

Electronic circuits often require an input voltage that differs from an available supply voltage. In order to provide the required input voltage, so-called switched-mode power supply units are therefore often used to compensate the difference between supply voltage and input voltage.

Since the electronic circuits are also often sensitive to voltage fluctuations, in particular to overvoltages, one or more fuses may be connected upstream of a switched-mode power supply unit, which fuses permanently interrupt a current feed of the switched-mode power supply unit in the event a tripping current is permanently exceeded. Recommissioning after replacement of the interrupting fuse (and, if necessary, elimination of the cause of the overcurrent) is possible.

### SUMMARY OF THE INVENTION

According to the present invention, a method for operating a switched-mode power supply unit and a voltage supply device are proposed.

A method according to the invention for operating a switched-mode power supply unit comprises capturing at least one operating parameter of the switched-mode power supply unit, determining, using the at least one operating parameter, a variable of the switched-mode power supply unit, said variable being dependent on an output power, comparing the variable dependent on the output power with a power threshold value, and carrying out a measure, which in particular comprises lowering the output power of the switched-mode power supply unit, if the determined variable exceeds the power threshold value. As a result, the switched-mode power supply unit and connected consumers can be protected from overcurrent or overvoltage. The variable dependent on an output power may in particular be the output line itself or, for example, a characteristic value proportional thereto.

In comparison to conventional fuses, a power limitation can already take place at a significantly lower power deviation. In particular, a switched-mode power supply unit particularly suitable for the invention comprises one or more elements from among a rectifier for rectifying an input AC voltage, a smoother for smoothing the resulting DC voltage, an electrically actuatable switch (e.g., MOSFET, IGBT) for “chopping” the DC voltage, a transformer for transforming the resulting AC voltage, a rectifier for rectifying the AC voltage, and a filter for filtering the DC voltage.

Advantageously, the operating parameter comprises one or more of the group consisting of input voltage of the switched-mode power supply unit, output voltage of the switched-mode power supply unit or a variable proportional thereto, e.g., determined from an auxiliary winding, operating state (1/0 or on/off) of the switched-mode power supply unit, duty cycle of a power switch of the switched-mode power supply unit, actuating voltage curve of the power switch, and voltage drop at a shunt. These operating parameters are on the one hand particularly easy to determine and on the other hand precisely characterize the output power of the switched-mode power supply unit.

Preferably, lowering the output power comprises limiting or switching off a current flowing through the power switch, in particular by opening a switch on the input side of the switched-mode power supply unit, and/or opening a switch on the output side of the switched-mode power supply unit. The consumer and, optionally, also the switched-mode power supply unit can thereby be protected from overloading as a result of electrical power that is too high.

In particular, the power threshold value corresponds to at most 150% of a maximum power of a consumer connected on the output side to the switched-mode power supply unit, regardless of the operating state. The better known the maximum permissible power is, the closer the power threshold value can be to the maximum power in order to prevent false trips. The power limitation can thus react in a particularly sensitive manner to the power threshold value being exceeded, which has a positive effect on the protective effect.

A voltage supply device according to the invention, which is designed in particular for connecting to a voltage supply source and for supplying a consumer, accordingly comprises, in particular in a common housing, a switched-mode power supply unit, a diagnostic circuit designed to capture at least one operating parameter of the switched-mode power supply unit, and to determine, using the at least one captured operating parameter, a variable of the switched-mode power supply unit, said variable being dependent on an output power; a comparator circuit designed to compare the variable determined by the diagnostic circuit with a power threshold value; and a power limiting circuit designed to lower the output power of the switched-mode power supply unit if the determined variable exceeds the power threshold value. The advantages explained herein with respect to embodiments of a method according to the invention therefore accordingly also apply analogously to the device and vice versa.

Advantageously, the diagnostic circuit for capturing the at least one operating parameter comprises one or more of the group consisting of voltage measuring circuit, current measuring circuit, shunt, time measuring circuit, frequency measuring circuit, and on-state capturing circuit.

Preferably, the comparator circuit is signal-conductively connected at a first input to an output of the diagnostic circuit, signal-conductively connected at an output to an input of the power limiting circuit, and optionally designed at a second input to receive a specification for the power threshold value. The latter allows flexible specification of the power threshold value. For example, in cases where different consumers are supplied by the switched-mode power supply unit (or one consumer that receives power differently in different states), the power threshold value may be variably selected as a function of the currently supplied consumer.

The power limiting circuit advantageously comprises a switch in a conduction path between an input of the voltage supply device and the switched-mode power supply unit and/or between the switched-mode power supply unit and an output of the voltage supply device, and/or a current limiting element and/or voltage limiting element, in particular an adjustable resistor, in a conduction path between the input of the voltage supply device and the switched-mode power supply unit and/or between the switched-mode power supply unit and the output of the voltage supply device. This can effectively limit the power.

### BRIEF DESCRIPTION OF THE DRAWINGS

Additional advantages and embodiments of the invention result from the description and the enclosed drawing.

The invention is illustrated schematically in the drawing on the basis of exemplary embodiments and is described below with reference to the drawing.

FIG. 1 shows an advantageous embodiment of a voltage supply device according to the invention in a circuit in a schematic representation as a block diagram.

FIG. 2 shows an advantageous embodiment of a method according to the invention in a schematic representation as a flow chart.

FIG. 3 shows exemplary possibilities for an embodiment of a voltage supply device according to the invention.

### DETAILED DESCRIPTION

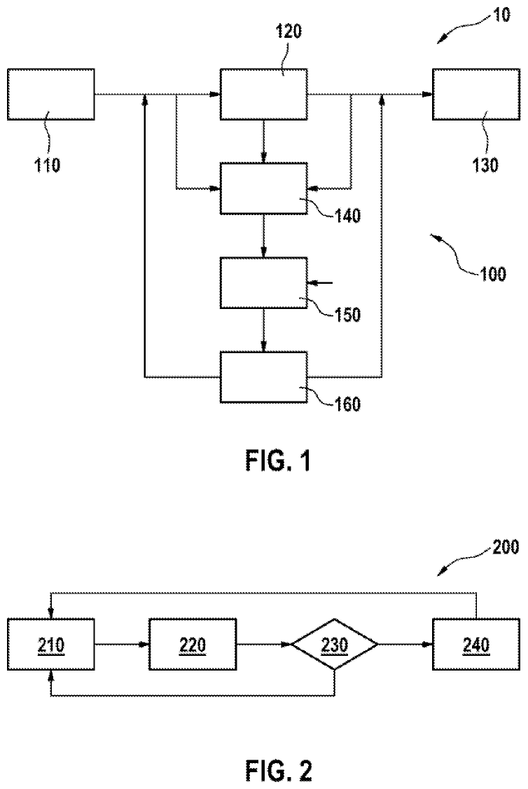

In FIG. 1, a circuit with an advantageous embodiment of a voltage supply device according to the invention is shown schematically in the form of a block diagram. In this case, the circuit as a whole is denoted by 10 and the voltage supply device is denoted by 100.

In FIG. 2, an advantageous embodiment of a method according to the invention is shown schematically in the form of a flow chart and denoted as a whole by 200.

The circuit 10 comprises a voltage supply source 110, a switched-mode power supply unit 120, and one or more consumers 130. The voltage supply source 110 is electrically conductively connected to the switched-mode power supply unit 120 and feeds it electrical energy at an input voltage level in operation. The switched-mode power supply unit 120 is designed, in operation, i.e., when powered by the voltage supply source 110, to convert the input voltage such that an output voltage of the switched-mode power supply unit 120 corresponds to a requirement of the at least one consumer 130. In particular, the output voltage of the switched-mode power supply unit does not have strong voltage fluctuations or spikes.

In order to ensure this, the voltage supply device 100 is equipped with a diagnostic circuit 140, which captures suitable operating parameters of the switched-mode power supply unit 120 during operation of the circuit 10 in a first method step 210 of the method 200, and determines therefrom in a second step 220 a variable of the switched-mode power supply unit 120, said variable being dependent on an output power. For example, the captured operating parameters may include the input voltage, an input-side current intensity, an on-state, a duty cycle of a power switch, the output voltage of the switched-mode power supply unit, an actuating voltage of the power switch, and/or a voltage drop at a shunt.

The variable determined in the second step 220, e.g., the output power itself, can be determined from a pair of values (e.g., output voltage and output-side current intensity or duty cycle and actuating voltage of the power switch) or from a plurality of pairs of values or combinations of values in connection with a suitable averaging with or without weighting. The diagnostic circuit 140 comprises corresponding means to enable such a computing operation, and may, for example, be provided in the form of a microcomputer, a dedicated circuit, a system-on-a-chip, or the like.

In order to check whether the output power determined in this way corresponds to the mentioned requirement of the at least one consumer 130, a comparator circuit 150 is provided in the voltage supply device 100. In a comparison step 230, said comparator circuit can compare the output power determined in step 220 with a comparative variable, e.g., a power threshold value or an input signal characterizing such a power threshold value. For example, a power threshold value may be permanently specified for this purpose, or the consumer 130 provides the comparator circuit 150 with a signal that contains information about a current maximum permissible power consumption. Of course, this signal may also be provided by another suitable component of the voltage supply device 100, the circuit 10, or from outside the circuit 10. In any case, such current information allows more flexible monitoring of the output power and, optionally, also the use of the voltage supply device 100 for simultaneously monitoring a plurality of switched-mode power supply units 120 and/or circuits 10. If the comparator circuit 150 determines in step 230 that the power threshold value is not being exceeded, the method 200 returns to step 210 in order to continue with the output power monitoring over the further course of time.

On the other hand, if the comparator circuit 150 determines in the comparison step 230 that the power threshold value is being exceeded, it outputs a corresponding signal to a power limiting circuit 160 of the voltage supply device 100.

In a step 240, the power limiting circuit 160 then carries out a measure that is suitable for limiting the output power of the switched-mode power supply unit 120 in such a way that the power threshold value is once again fallen below in the subsequent period of time. For this purpose, the power limiting circuit 160 may, for example, increase an input-side resistance between the voltage supply source 110 and the switched-mode power supply unit 120 so that the input voltage is lowered. An alternative or additional possibility would be an output-side intervention, for example by increasing an output-side resistance between switched-mode power supply unit 120 and consumer 130. Adaptation of the duty cycle of the mentioned power switch or similar measures are also provided in embodiments of the method 200. Ultimately, total isolation of the voltage supply source 110 from the switched-mode power supply unit 120 and/or of the switched-mode power supply unit 120 from the at least one consumer 130 may also be provided as a measure in order to protect the consumer 130 and also the switched-mode power supply unit 120 from a power consumption that is too high, for example by stopping the actuation of the power switch. If a power limiting measure has taken place in step 240, the method 200 may advantageously return to step 210 in order to check the success of the measure and, if necessary, to carry out further steps 240, or to resume and monitor the control operation over the further course of time.

It is expressly pointed out here that certain steps of the method 200 may, optionally, also be carried out in a different, e.g., reverse, order, or a plurality of steps may be combined into a single step. It may also be advantageous to design certain components of the voltage supply device 100 in an integrated manner rather than separately from one another. For example, the diagnostic circuit 140 may be combined with the comparator circuit 150 and parts of the power limiting circuit 160 and provided as, for example, a single chip or microcomputer.

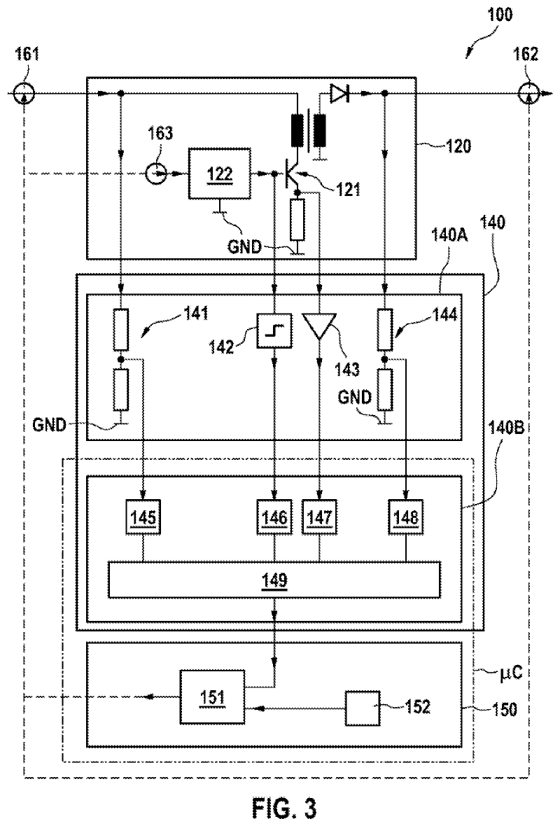

FIG. 3 shows exemplary possibilities for embodiments of a voltage supply device 100 according to the invention, as shown more generally in FIG. 1.

In an exemplary embodiment, the switched-mode power supply unit 120 comprises a power switch 121 and an actuating circuit 122. In the example shown, the switched-mode power supply unit 120 includes a transformer comprising at least two coils electrically inductively coupled to one another. A first one of the coils, which is arranged on the input side, is connected via the power switch 121 and via a current measuring resistor or shunt to ground. A control connection of the power switch 121 is connected to an output of the actuating circuit 122.

A second of the coils is arranged on the output side and is connected to ground on the one hand and via a diode to an output of the switched-mode power supply unit on the other hand. The diode is connected in the forward direction between the second coil and the output of the switched-mode power supply unit 120.

In a further exemplary embodiment, the diagnostic circuit 140 is divided into a substantially analog first circuit part 140A and a substantially digital second circuit part 140B.

For example, the first circuit part 140A comprises a first voltage divider 141 for monitoring an input voltage of the switched-mode power supply unit 120, said voltage divider being connected on the input side to the input of the switched-mode power supply unit 120 and the voltage tap of said voltage divider being connected to a signal input of a first analog-to-digital converter 145 of the second circuit part 140B. For example, a second voltage divider 144 may alternatively or additionally be provided for monitoring an output voltage of the switched-mode power supply unit 120. For this purpose, the second voltage divider 144 is connected on the input side to the output of the switched-mode power supply unit 120. The voltage tap of the second voltage divider 144 is in turn connected to an input of a further analog-to-digital converter 148 of the second circuit part 140B of the diagnostic circuit 140.

The first circuit part 140A of the diagnostic circuit 140 may alternatively or additionally also comprise a logic circuit 142, which monitors the control connection of the power switch 121 of the switched-mode power supply unit 120 and is connected to an interface 146 of the second circuit part 140B of the diagnostic circuit 140. In particular, this logic circuit may send a signal to the interface 146, said signal containing information about the switching state (e.g., “open” or “closed”) of the power switch 121.

The first circuit part 140A of the diagnostic circuit may alternatively or additionally also comprise an amplifier 143, which amplifies a voltage dropping at the shunt and indicating a current flowing through the power switch 121 and is connected on the output side to an input of a further analog-to-digital converter 147 of the second circuit part 140B of the diagnostic circuit 140.

In addition to the aforementioned analog-to-digital converters 145, 147, 148 and/or the interface 146, the second circuit part 140B of the diagnostic circuit 140, alternatively or additionally comprises a calculation unit 149 designed to calculate, from the digital or digitalized received signals, a variable of the switched-mode power supply unit 120, said variable being dependent on an output power, e.g., the output power itself. For example, the output power may be calculated as a product of input voltage (determined by means of the first voltage divider 141) and input current (determined using the amplifier 147) minus a known or predetermined power loss that takes into account an efficiency of the transformer of the switched-mode power supply unit 120. A calculation using the input voltage of the switched-mode power supply unit 120 and a duty cycle that may be determined using the signal of the logic circuit 142 in connection with a time measurement is also advantageously provided in certain embodiments.

For example, the output power P₂ in the case of a so-called flyback converter may be calculated using the following formulas:

P₂=I₂·V₂

The output voltage V₂ can be calculated from the ratio of the winding numbers N₁, N₂ of the transformer, the duty cycle D, and the input voltage V₁:

$${V}_{2} = \frac{{N}_{2}}{{N}_{1}} \frac{D}{1 - D} {V}_{1}$$

The output current I₂ results from the input voltage V₁, the duty cycle D, the inductance Lₘ of the transformer, the output voltage V₂, and the switching frequency f as:

$${I}_{2} = \frac{{V}_{1}^{2} {D}^{2}}{2 \cdot {L}_{m} \cdot {V}_{2} \cdot f}$$

An efficiency η of the transformer different from 1 lowers the output power P₂ according to: P₂=η·P₁

The diagnostic circuit 140, in particular the second circuit part 140B or its calculation unit 149, may also be implemented in the form of a so-called neural network or a replica of such a network. This provides the advantage that learning effects or results improving over time can be achieved. In particular, the neural network can weigh the supplied operating parameters according to learned values and can decide whether the output power is above a power threshold value or not.

In calculating the power currently received, a combination of the power calculation of current and voltage, as well as voltage and duty cycle, depending on the operating point of the switched-mode power supply unit 120, is also useful in order to achieve optimal results. For example, at high input voltages, a current to be evaluated may be so small that an unavoidable measurement error can lead to an only highly inaccurate calculation of the power. Accordingly, in such situations, a calculation using the duty cycle is advantageous.

In the example shown in FIG. 3, the comparator circuit 150 comprises a comparator 151 and a specification element 152. The specification element outputs a signal during operation of the voltage supply device 100, said signal describing a maximum permissible output power of the switched-mode power supply unit, in particular the power threshold value already mentioned several times. A first input of the comparator 151 is connected to an output of the diagnostic circuit 140, in particular to an output of the calculation unit 149. A second input is connected to an output of the specification element 152. In operation, the comparator 151 compares the signals applied to the first and second inputs and outputs, for example as a function of the difference between the two signals, an output signal that contains information about the compliance with the power threshold value.

The output signal of the comparator causes the power limiting device 160 already explained with respect to FIG. 1 to limit the output power of the switched-mode power supply unit 120. For this purpose, the output signal of the comparator 151 of the comparator circuit 150 may act on an actuating element of the power limiting circuit 160. In FIG. 3, possible positions 161, 162, 163 for such actuating elements are shown schematically. In this context, actuating elements may be switches or adjustable resistors, for example. For example, at positions 161 and 162, the conduction path may be interrupted by the switched-mode power supply unit 120 or may be power-limited via a resistor. For example, if the output signal of the comparator 151 acts on an input of the actuating circuit 122 of the switched-mode power supply unit 120 (position 163), the duty cycle of the power switch 121 may be influenced or said power switch may be permanently opened in order to interrupt the conduction path through the switched-mode power supply unit 120 or limit its forward power. In the latter case (actuating element at position 163), the actuating circuit 122 of the switched-mode power supply unit may consequently function simultaneously as the power limiting circuit 160 of the voltage supply device 100.

Parts of the voltage supply device 100 may be provided combined into a single microcomputer μC. This is indicated in FIG. 3 in the form of a dot-dashed box, which in this example comprises the second circuit part 140B as well as the comparator circuit 150, i.e., substantially digital circuits.

It is expressly emphasized here that the illustrated embodiment is merely an exemplary embodiment and that not all components need to be present in order to provide a voltage supply device 100 according to the invention. For example, the diagnostic circuit 140 may also have more or less and/or other components in order to determine the output power of the switched-mode power supply unit 120. The mentioned division of the diagnostic circuit 140 into the first 140A and second 140B circuit parts is also to be understand merely as an example and is not necessarily provided in all embodiments in the manner shown. In embodiments, it may, for example, also be provided that the microcomputer μC comprises fewer or further parts of the voltage supply device 100, for example additionally the actuating circuit 122 of the switched-mode power supply unit 120 and/or other components. It should furthermore be noted that a specific embodiment of a device part, such as the switched-mode power supply unit 120, described with respect to FIG. 3 is to be understood as independent of the specific embodiment of the remaining device parts.

1. A method (200) for operating a switched-mode power supply unit (120), the method comprising:
capturing (210), via a diagnostic circuit, at least one operating parameter of the switched-mode power supply unit (120),
determining (220), using the at least one operating parameter and via the diagnostic circuit, a variable of the switched-mode power supply unit (120), said variable being dependent on an output power,
comparing (230), via a comparator circuit, the variable dependent on the output power with a power threshold value, and
lowering the output power of the switched-mode power supply unit (120), via a power limiting circuit, when the determined output power exceeds the power threshold value.

2. The method (200) according to claim 1, wherein the operating parameter comprises one or more of the group consisting of input voltage of the switched-mode power supply unit, output voltage of the switched-mode power supply unit, operating state of the switched-mode power supply unit, duty cycle of a power switch of the switched-mode power supply unit, actuating voltage of the power switch, and voltage drop at a shunt.

3. The method (200) according to claim 1, wherein lowering the output power comprises limiting or switching off a current flowing through a power switch of the switched-mode power supply unit (120) and/or opening a switch on the output side and/or on the input side of the switched-mode power supply unit (120).

4. The method (200) according to one of the preceding claim 1, wherein the power threshold value corresponds to at most 150%, 125%, 110%, 105%, 102%, or 101% of a maximum power of a consumer (130) connected on the output side to the switched-mode power supply unit (120).

5. The method (200) according to claim 1, wherein determining (220) the at least one variable dependent on the output power and/or comparing (230) the variable dependent on the output power with the power threshold value is carried out using a neural network.

6. A voltage supply device (100) comprising
a switched-mode power supply unit (120);
a diagnostic circuit (140) designed to capture at least one operating parameter of the switched-mode power supply unit (120) and to determine, using the at least one captured operating parameter, a variable of the switched-mode power supply unit (120), said variable being dependent on an output power;
a comparator circuit (150) designed to compare the variable determined by the diagnostic circuit (140) with a power threshold value; and
a power limiting circuit (160) designed to lower the output power of the switched-mode power supply unit (120) if the determined output power exceeds the power threshold value.

7. The voltage supply device (100) according to claim 6, wherein the diagnostic circuit (140) for capturing the at least one operating parameter comprises one or more of the group consisting of voltage measuring circuit, current measuring circuit, shunt, time measuring circuit, frequency measuring circuit, and on-state capturing circuit.

8. The voltage supply device (100) according to claim 6, wherein the comparator circuit (150) is signal-conductively connected at a first input to an output of the diagnostic circuit (140), signal-conductively connected at an output to an input of the power limiting circuit (160), and optionally designed at a second input to receive a specification for the power threshold value.

9. The voltage supply device (100) according to claim 6, wherein the power limiting circuit (160) comprises a switch in a conduction path between an input of the voltage supply device (100) and the switched-mode power supply unit (120) and/or between the switched-mode power supply unit (120) and an output of the voltage supply device (100), and/or a current limiting element and/or voltage limiting element in a conduction path between the input of the voltage supply source (110) and the switched-mode power supply unit (120) and/or between the switched-mode power supply unit (120) and the output of the voltage supply device (100).

10. The voltage supply device (100) according to claim 6, wherein a neural network is implemented in the diagnostic circuit (140).
